(19) United States
(12) Patent Application Publication
(10) Pub. No.: US 2020/0090194 A1
(43) Pub. Date: Mar. 19, 2020

(54) AUTOMATED RESOURCE ALLOCATION BASED ON PREDICTIVE ANALYSIS

(71) Applicant: BANK OF AMERICA CORPORATION, Charlotte, NC (US)

(72) Inventors: Manu Jacob Kurian, Dallas, TX (US); Gopikrishna Nemalikanti, Frisco, TX (US); Albena Noveva Fairchild, Indian Trail, NC (US); Jeffrey A. Young, Cohoes, NY (US); Stanley J. Schwartz, Waxhaw, NC (US); Mahesh Kumar Bhashetty, Plainsboro, NJ (US); Ramanathan Sankarasubramanian, Coppell, TX (US)

(21) Appl. No.: 16/130,434

(22) Filed: Sep. 13, 2018

(51) Int. Cl. G06Q 30/02; H04L 29/08; G06Q 20/12; G06Q 30/06; G01C 21/34; G06Q 10/08

(52) U.S. Cl. CPC G06Q 30/0202; H04L 67/12; G06Q 20/12; H04L 67/18; G01C 21/3492; G06Q 10/087; G06Q 30/0633

(57) ABSTRACT

The present invention provides for automated resource allocation based on predictive analysis of allocation parameters for the resource to be allocated. In specific embodiments of the invention, the analytical analysis that predicts the future allocation parameters is based at least on the entities historical resource allocation events, including, but not limited to, preferred types of the resource, amount/volume of previous resource allocations, timing of previous resource allocation and the like. In other embodiments of the invention, the analytical analysis that predicts the future allocation parameters is further based on the current or predicted location of resource allocation entities and/or the current or predicted travel route of at least one of the entities. In response to the analysis, a resource request signal, which may indicate resource amount and/or type, is generated and communicated to resource allocator configured to automatically allocate the resource to the entity(s) in response to receiving the request.

### FIELD

In general, embodiments of the invention relate to resource allocation within a distributed computing environment, and more specifically, automated resource allocation based on predictive analysis.

### BACKGROUND

Resource allocation in a distributed computing environment is becoming a more informed and intuitive process. In this regard, resource allocation may take into account various different factors/parameters associated with the entity to whom the resource is allocated in order to insure the accuracy of the resource being allocated in terms of resource type, resource amount, the location at which the resource is to be allocated.

Systems for providing communications between and amongst devices are known where inter-related communication devices, often referred to as smart devices, may include communications modules, processors and applications that allow the devices to communicate with one another, and with other devices and/or systems, over a network. Such systems allow the devices to collect and exchange data and are commonly referred to as the Internet-of-Things (IoT) and IoT devices. IoT devices have been developed that have the capability to detect a need for a resource and initiate the allocation process.

However, systems, apparatus process and the like are needed for more effective resource allocation, which takes into account various factors/parameters associated with the entities to whom the resource is allocated. In this regard, the factors/parameters may be analytically analyzed to predict future usage needs for the resource by the entities and allocate the resource accordingly. In addition, a need exists to implement IoT devices and systems, such that the allocation may occur dynamically and take into account factors/parameters acquired by the IoT devices.

### SUMMARY OF THE INVENTION

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing systems, apparatus, computer program products, and the like for automated resource allocation based on predictive analysis of allocation parameters of the entities to whom the resource is to be allocated. In specific embodiments of the invention, the analytical analysis that predicts the future allocation parameters of the entities is based at least on the entities historical resource allocation events, including, but not limited to, preferred types of the resource, amount/volume of previous resource allocations, timing of previous resource allocation and the like. In response to conducting the analytical analysis and predicting future usage needs, a resource allocation request signal, which may indicate resource amount and/or type, is generated and electronically communicated to resource allocator configured to automatically allocate the resource to the entity(s) in response to receiving the request.

In specific embodiments of the invention the current or future location of one or more of the entities is determined and the future allocation parameters of the entities are predicted based further on the current or future location of one or more of the entities. In other specific embodiments of the invention a current or future travel route for at least one of the one or more entities is determined, along with one or more resource suppliers proximate in location to the current or future travel route. In such embodiments of the invention, the resource allocation signal is communicated to at least one of the one or more resource suppliers.

A system for allocating resources defines first embodiments of the invention. The system includes an Internet-of-Things (IoT) device having a first computing platform including a first memory storing first instructions and at least one first processor in communication with the memory. The at least one first processor is configured to execute the first instructions to receive an input signal that detects a need to allocate a resource to one or more entities. The at least one first processor is further configured to execute the first instructions to, in response to receiving the input (i) analyze historical allocation events associated with the one or more entities and the resource, and (ii) analytically predict future allocation parameters for the resource and the one or more entities based at least on the analyzation of the historical allocation events. In addition, the at least one first processor is further configured to execute the first instructions to, in response to predicting the future allocation parameters for the resource, generate and communicate a resource allocation signal. The system additionally includes a resource allocation apparatus having a second computing platform including a second memory storing second instructions and at least one second processor in communication with the second memory. The at least one second processor is configured to execute the second instructions to, in response to receiving the resource allocation signal, conduct a resource acquisition event that allocates the resource to the one or more entities.

In specific embodiments of the system, the at least one first processor is configured to execute the first instructions to determine at least one of a current location or predicted location of at least one of the one or more entities and analytically predict the future allocation parameters for the resource and the one or entities based further on the current location or predicted location of at least one of the entities. In further related embodiments of the system, the at least one first processor is configured to execute the first instructions to, in response to predicting the future allocation parameters for the resource, generate and communicate the resource allocation signal that indicates an amount of the resource to be allocated to at least one of the one or more entities based on the predicted usage parameters.

In other specific embodiments of the system, the at least one first processor is configured to execute the first instructions to determine (i) a current or future travel route for at least one of the one or more entities and (ii) one or more resource suppliers proximate in location to the current or future travel route, and generate and communicate the resource allocation signal to at least one of the one or more resource suppliers.

In additional embodiments of the system, the at least one first processor is configured to execute the first instructions to analyze the historical allocation events associated with the one or more entities and the resource to determine one or more types of the resource previously allocated to at least one of the one or more entities. In such embodiments of the system, the at least one first processor may be further configured to execute the first instructions to determine (i) a current or future travel route for at least one of the one or more entities and (ii) one or more resource suppliers proximate in location to the current or future travel route and capable of allocating at least one of the one or more types of resource previously allocated to at least one of the one or more entities, and generate and communicate the resource allocation signal to at least one of the one or more resource suppliers.

In still further specific embodiments of the system, the at least one first processor is configured to execute the first instructions to determine a predicted location of at least one of the one or more entities and receive the input that detects a need to allocate the resource to the one or more entities at the predicted location. In related embodiments of the system, the at least one first processor is further configured to execute the first instructions to determine one or more resource suppliers proximate in location to the predicted location and capable of allocating the resource at a time associated with the predicted location, and generate and communicate the resource allocation signal to the one or more resource suppliers.

In still further embodiments of the system, the IoT device further comprises one or sensors in communication with the first processors, wherein the one or more sensors are configured to detect the need to allocate the resource to the one or more entities and generate the input signal.

An Internet-of-Things (IoT) apparatus defines second embodiments of the invention. The IoT apparatus includes a computing platform having a memory storing instructions and at least one processor in communication with the memory. The processor(s) is configured to execute the instructions to receive an input signal that detects a need to allocate a resource to one or more entities and, in response to receiving the input, (i) analyze historical allocation events associated with the one or more entities and the resource and (ii) analytically predict future allocation parameters for the resource and the one or more entities based at least on the analyzation of the historical allocation events. The processor(s) is further configured to execute the instructions to, in response to predicting the future allocation parameters for the resource, generate and communicate a resource allocation signal. The receipt of the resource allocation signal by a resource allocation apparatus prompts a resource acquisition event that allocates the resource to the one or more entities.

In specific embodiments of the apparatus, the at least one processor is configured to execute the instructions to determine at least one of a current location or predicted location of at least one of the one or more entities, and analytically predict the future allocation parameters for the resource and the one or entities based further on the current location or predicted location of at least one of the entities.

In other specific embodiments of the IoT apparatus, the at least one processor is configured to execute the instructions to, in response to predicting the future allocation parameters for the resource, generate and communicate the resource allocation signal that indicates an amount of the resource to be allocated to at least one of the one or more entities based on the predicted usage parameters.

In still further specific embodiments of the IoT apparatus, the at least one processor is configured to execute the instructions to analyze the historical allocation events associated with the one or more entities and the resource to determine one or more types of the resource previously allocated to at least one of the one or more entities, determine (i) a current or future travel route for at least one of the one or more entities, and (ii) one or more resource suppliers proximate in location to the current or future travel route and capable of allocating at least one of the one or more types of resource previously allocated to at least one of the one or more entities, and generate and communicate the resource allocation signal to at least one of the one or more resource suppliers.

In other specific embodiments of the IoT apparatus, the at least one processor is configured to execute the instructions to determine (i) a current or future travel route for at least one of the one or more entities, and (ii) one or more resource suppliers proximate in location to the current or future travel route, and generate and communicate the resource allocation signal to at least one of the one or more resource suppliers.

In still further specific embodiments of the IoT apparatus, the at least one processor is configured to execute the instructions to determine a predicted location of at least one of the one or more entities, and receive the input that detects a need to allocate the resource to the one or more entities at the predicted location. In related embodiments of the IoT device, the at least one processor is configured to execute the instructions to determine one or more resource suppliers proximate in location to the predicted location and capable of allocating the resource at a time associated with the predicted location, and generate and communicate the resource allocation signal to the one or more resource suppliers.

A computer program product including a non-transitory computer-readable medium defines third embodiments of the invention. The computer-readable medium includes a first set of codes for causing a computer to receive an input signal that detects a need to allocate a resource to one or more entities. The computer-readable medium additionally includes a second set of codes for causing a computer to, in response to receiving the input, analyze historical allocation events associated with the one or more entities and the resource and analytically predict future allocation parameters for the resource and the one or more entities based at least on the analyzation of the historical allocation events. In addition, the computer-readable medium includes a third set of codes for causing a computer to, in response to predicting the future allocation parameters for the resource, generate and communicate a resource allocation signal. Receipt of the resource allocation signal by a resource allocator prompts a resource acquisition event that allocates the resource to the one or more entities.

In specific embodiments of the computer program product, the computer-readable medium further includes a fourth set of codes for causing a computer to determine at least one of a current location or predicted location of at least one of the one or more entities. In such embodiments of the computer program product the second set of codes is further configured to a fifth set of codes for analytically predict the future allocation parameters for the resource and the one or entities based further on the current location or predicted location of at least one of the entities.

In other specific embodiments of the computer program product, the third set of codes is further configured to cause the computer to, in response to predicting the future allocation parameters for the resource, generate and communicate the resource allocation signal that indicates an amount of the resource to be allocated to at least one of the one or more entities based on the predicted usage parameters.

In yet further specific embodiments of the computer program product, the second set of codes is further configured to cause the computer to analyze the historical allocation events associated with the one or more entities and the resource to determine one or more types of the resource previously allocated to at least one of the one or more entities. In such embodiments of the computer program product, the computer-readable medium further includes a fourth set of codes for causing a computer to determine the at least one processor is configured to execute the instructions to determine (i) a current or future travel route for at least one of the one or more entities and (ii) one or more resource suppliers proximate in location to the current or future travel route and capable of allocating at least one of the one or more types of resource previously allocated to at least one of the one or more entities. In such embodiments of the computer program product, the third set of codes is further configured to cause the computer to generate and communicate the resource allocation signal to at least one of the one or more resource suppliers.

Thus, systems, apparatus, methods, and computer program products herein described in detail below provide for automated resource allocation based on predictive analysis of allocation parameters of the entities to whom the resource is to be allocated. In specific embodiments of the invention, the analytical analysis that predicts the future allocation parameters of the entities is based at least on the entities historical resource allocation events, including, but not limited to, preferred types of the resource, amount/volume of previous resource allocations, timing of previous resource allocation and the like. In other embodiments of the invention, the analytical analysis that predicts the future allocation parameters is further based on the current or predicted location of at least one of the entities and/or the current or predicted travel route of at least one of the entities. In response to conducting the analytical analysis and predicting future usage needs, a resource allocation request signal, which may indicate resource amount and/or type, is generated and electronically communicated to resource allocator configured to automatically allocate the resource to the entity(s) in response to receiving the request.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 provides a schematic diagram of an exemplary system for automated resource allocation based on predictive analysis, in accordance with embodiments of the present invention;

FIG. 2 provides a block diagram on apparatus configured for automated resource allocation based on predictive analysis, in accordance with embodiments of the present invention; and

FIG. 3 provides a flow diagram of a method for automated resource allocation based on predictive analysis, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As will be appreciated by one of skill in the art in view of this disclosure, the present invention may be embodied as an apparatus (e.g., a system, computer program product, and/or other device), a method, or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as JAVA, PERL, SMALLTALK, C++ or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or apparatuses (the term “apparatus” including systems and computer program products). It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

According to embodiments of the invention described herein, various systems, apparatus, methods, and computer program products are herein described for automated resource allocation based on predictive analysis of allocation parameters of the entities to whom the resource is to be allocated. In specific embodiments of the invention, the analytical analysis that predicts the future allocation parameters of the entities is based at least on the entities historical resource allocation events, including, but not limited to, preferred types of the resource, amount/volume of previous resource allocations, timing of previous resource allocation and the like. In response to conducting the analytical analysis and predicting future usage needs, a resource allocation request signal, which may indicate resource amount and/or type, is generated and electronically communicated to resource allocator configured to automatically allocate the resource to the entity(s) in response to receiving the request.

In specific embodiments of the invention the current or future location of one or more of the entities is determined and the future allocation parameters of the entities are predicted based further on the current or future location of one or more of the entities. In other specific embodiments of the invention a current or future travel route for at least one of the one or more entities is determined, along with one or more resource suppliers proximate in location to the current or future travel route. In such embodiments of the invention, the resource allocation signal is communicated to at least one of the one or more resource suppliers.

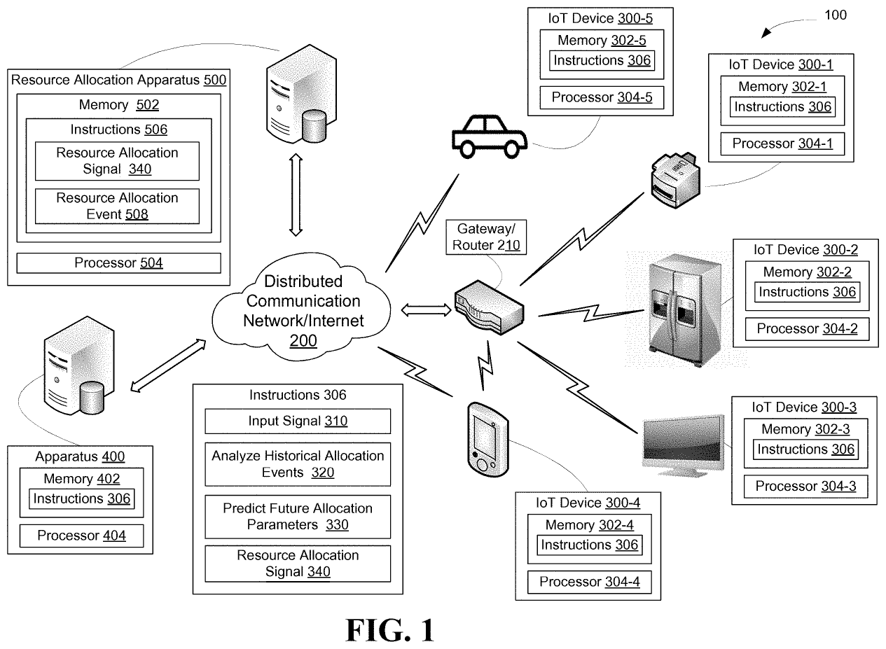

Referring to FIG. 1, a schematic diagram is provided of an exemplary system 100 for automated resource allocation based on predictive analysis, in accordance with embodiments of the present invention. In accordance with embodiments of the present invention, the system 100 is implemented within a distributed computing network 200, such as the Internet and/or cellular networks or the like configured to receive and transmit wired or wireless signals. The system 200 may additionally include one or more gateway devices 210, such as a router or the like configured to receive/transmit wired or wireless signals from/to devices, such as Internet-of-Things (IoT) devices 300 and the distributed communication network 200. In this regard, each gateway device 210 and corresponding IoT devices 300 comprise a wireless local area network (WLAN).

IOT devices 300 may comprise any device equipped with computing means, such as processors, software, sensors and network connectivity, which enables the device to wirelessly connect with a network and exchange data. In the example shown in FIG. 1, the IoT devices may include, but are not limited to, printer device 300-1; kitchen appliance 300-2, such as a “smart refrigerator”; multimedia output device 300-3, such as a “smart television”; mobile communication device 300-4, such as a “smart phone”; and vehicle 300-5. The IoT devices may be configured to connect to the distributed communication network 200 via gateway device 300 or the IoT devices may directly connect with the distributed communication network 200 using a cellular connection or the like.

The IoT devices 300 include a computing platform including a memory 302 and at least processor 304 in communication with the memory 302. The memory stores instructions 306 that are executable by the processor 304. In other embodiments of the invention at least a portion the instructions 306 may be stored and/or executed by other network devices, such as gateway device 210 and/or network apparatus 400. The instructions 306 are configured to receive an input signal 310 that detects a need to allocate a resource to one or more entities. The input signal 310 may be provided by one or more sensors (not shown in FIG. 1) in the IoT device or the input signal 310 may be provided by a user of the IoT device 300. For example, a sensor within printer device 300-1 or vehicle 300-5 may detect a need for consumable resource (e.g., ink, oil, filters, hoses and the like), a sensor within the kitchen appliance device 30-2 may detect a need to replenish a consumable food resource and the like. In other instances an entity/user associated with the IoT device 300 may provide one or more inputs that indicate a need to allocate a resource to the entity/user or entities/users associated with the user (e.g., family members or other individuals within the residence of the user/entity). In those embodiments of the invention in which either the subsequent historical event analysis 320 or predictive future resource usage demand analysis 330 are performed at devices other than the IoT device 300 (e.g., at the gateway device 210 and/or the network apparatus/server 400) the input signal 310 may be generated at the IoT device 300 and communicated to the gateway device 210 and/or network apparatus 400 via the WLAN and/or distributed communication network 200.

The instructions 306 are further include instructions to, in response to receiving the input signal 310, analyze historical allocation events 320 associated with the one or more entities and the resource. In this regard, the IoT 300 or, in some embodiments the gateway device 210 and/or network apparatus 400 may communicate with an allocation event repository (not shown in FIG. 1) to access and/or retrieve data associated with previous allocation events associated with the one or more entities and the resource detected to have an allocation need. The historical allocation event data may be analyzed to determine one or more parameters associated with the historical allocation events, such as, but not limited to, preferred types of the resource, preferred resource allocators, amount/volume of previous resource allocations, timing/location of previous resource allocation and the like.

The instructions 306 further include instructions to predict future allocation parameters for the resource 330 based at least on the analyzation of the historical allocation events. The future allocation parameters may include the type of the resource (e.g., brand or the like); timing of the resource allocation (e.g., date and/or time of day), the resource allocator/provider, the amount of the resource to be allocated, the location for the resource allocation and the like.

Further, the instructions 306 include instructions, in response to predicting the future allocation parameters for the resource, generate and communicate a resource allocation signal 340 to one or more resource allocators/providers or the entities. The resource allocator signal may include one or more of the allocation parameters including, but not limited to, the resource allocator(s)/provider(s), the type of the resource, the amount of the resource to be allocated, the location of the allocation and the like.

The system 100 additionally includes resource allocation apparatus 500 that includes memory 502 and at least one processor 504 in communication with memory 502. Memory 502 stores instructions 506 that are executed by processor 504 and configured to receive the resource allocation signal 340 and, in response conduct a resource allocation event 508 that allocates the resource to the one or more entities in accordance with the allocation parameters included in the resource allocation signal 340. Specifically, the resource allocation event 508 may be for a specified type of the resource, conducted by a specified resource allocator/provider, at a specified time (e.g., date and/or time of day), for a specified resource amount, at a specified allocation location and the like.

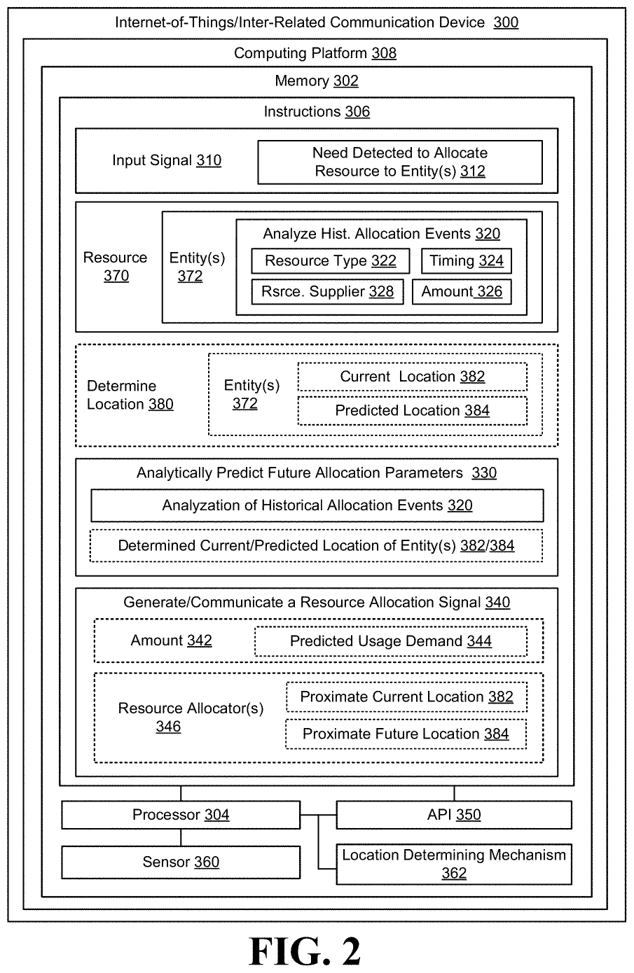

Referring to FIG. 2 a block diagram is presented of an Internet-of-Things (IoT) device 300 otherwise referred to as an Inter-related communication device, in accordance with embodiments of the present invention. In addition to providing more details for the system 100 and the IoT device 300, FIG. 2 provides various optional embodiments of the IoT device 300 and system 10. As shown and described in relation to FIG. 1, the IOT device may comprise any device equipped with computing means, such as processors, software, sensors and network connectivity, which enables the device to wirelessly connect with a network and exchange data. The IoT device 100 includes a computing platform 308 having a memory 302 storing instructions 306 therein, and a processor 304 in communication with the memory. The memory 302 may comprise volatile and non-volatile memory, such as read-only and/or random-access memory (RAM and ROM), EPROM, EEPROM, flash cards, or any memory common to computer platforms).

The processor 304 may be application-specific integrated circuits (“ASICs”), or other chipsets, logic circuits, or other data processing device(s). Processor 304 may execute an application programming interface 350 (“API”) that interfaces with any resident programs (i.e., instructions 306) stored in the memory 302 of the computing platform 308. Processor 304 may include various processing subsystems (not shown in FIG. 2) embodied in hardware, firmware, software, and combinations thereof, that enable the functionality of the computing platform 308 and the operability of the computing platform 308 on a distributed computing network 200 that allows for the computing platform 308 to communicate with the distributed computing network 200. For example, processing subsystems allow for initiating and maintaining communications and exchanging data with other networked devices, including resource allocation apparatus 500 (shown in FIG. 1). For the disclosed aspects, processing subsystems of processor 304 may include any subsystem used in conjunction with instructions 306 and related, codes, routines, sub-routines, algorithms, sub-algorithms, modules, sub-modules thereof.

The computing platform 308 additionally includes communication mechanism (not shown in FIG. 2) embodied in hardware, firmware, software, and combinations thereof, that enables electronic communications between the computing platform 308 and other platforms, apparatus and/or devices, such resource allocation apparatus 500 and network apparatus 400. Thus, communication mechanism may include the requisite hardware, firmware, software and/or combinations thereof for establishing and maintaining a network communication connection.

The memory 306 of computing platform 308 stores instructions which are configured to perform automated resource allocation based on predictive analysis. The instructions may be executed in their entirety on the IoT device 300 or by a device in communication with the IoT device 300 (e.g., gateway/router device 210 or network apparatus 400). The instructions 306 are configured to receive an input signal 310. The input signal 310 indicates detection of a need to allocate 312 a resource to at least one entity. The input signal 310 may be provided by one or more sensors 360 disposed within in the IoT device 300 or the input signal 310 may be provided by a user of the IoT device 300. For example, a sensor 360 within printer device 300-1 or vehicle 300-5 may detect a need for consumable resource (e.g., ink, oil, filters, hoses and the like), a sensor 360 within the kitchen appliance device 30-2 may detect a need to replenish a consumable food resource and the like. In other instances an entity/user associated with the IoT device 300 may provide one or more input signals 310 that indicate a need to allocate a resource to the entity/user or entities/users associated with the user (e.g., family members or other individuals within the residence of the user/entity).

In specific embodiments of the invention, the instructions 306 may be configured such that receipt of the input signal triggers analyzation of historical allocation events 320 associated with one or more entities 372 and the resource 370. Analyzation of historical allocation events 320 may include accessing and retrieving allocation event data from a network-accessible allocation event repository (e.g., purchase transaction history database or the like). The historical allocation events 320 may be analyzed to determine a preferred resource type 432, preferred timing for resource allocation, previous resource allocation amounts 326, preferred resource allocator/provider or the like.

In other specific embodiments of the invention, the instructions 306 may be configured to determine location 380 of one or more of the entities/users. The location may be the current location 382 of the one or more users, which may be determined by location-determining mechanisms 362 in the IoT device 300 (e.g., Global Positioning System (GPS) devices in a smart phone, vehicle or the like) or the location may be a predicted future location 384 of the entity(s). The predicted future location of the entity may be determined based on analyzing the historical allocation event data (e.g., travel allocations associated with a specific location or the like) or using other data associated with sensors 350 in the IoT device or the user (e.g., accessing social media associated with the user or the like to determine future locations). Moreover, the instructions 306 may include determining a current location 382 of one or more of the entities along a known or predicted travel route and/or a predicted future location 384 along the known or predicted travel route. The known or predicted travel route may be determined based on historical location data associated with the entity(s) and/or analyzing the historical allocation event data (e.g., travel allocations associated with a specific location or the like). In specific embodiments of the invention, the determination of the location 380 of the entity(s) may be triggered by receipt of the input signal 310 while in other embodiments of the invention, the determination of the location 360 of the entity may trigger the input signal 310 (i.e., the location of the entity or the predicted future location of the entity may dictate the need to allocate a resource to the entity).

The instructions 306 further include instructions to predict future allocation parameters 330 for the resource 370 based at least on the analyzation of the historical allocation events 320 and, in further embodiments, the determined current 382 or predicted location 384 of one or more of the entities. The future allocation parameters may include the type of the resource (e.g., brand or the like); timing of the resource allocation (e.g., date and/or time of day), the resource allocator/provider, the amount of the resource to be allocated, the location for the resource allocation and the like.

For example, the determination of location may identify which entities (e.g., household members) are currently or will be in the future be located at the location of the resource allocation (e.g., place of residence or work), such that, a determination of resource allocation may occur (i.e., whether resource should or should not be allocated based on entity location) and/or the specified amount of the resource allocation may be determined (i.e., consistent with the number of entities/users currently located or in the future located at the resource allocation site). In addition, determination of those entities/users currently located at the resource allocation location or those entities/users who will in the future be located at the resource allocation location may be determinative of the type of resource that is allocated (i.e., the type of resource preferred by the entities/users currently at the resource allocation location or will be in the future located at the resource allocation location).

The instructions 306 further include instructions to, in response to predicting the future allocation parameters for the resource, generate and communicate a resource allocation signal 340 to one or more resource allocators/providers. The resource allocator signal may include one or more of the allocation parameters including, but not limited to, the resource allocator(s)/provider(s) 346, the type of the resource, the amount 342 of the resource to be allocated based on a predicted usage demand, the location of the allocation and the like. The resource allocator 346 may be proximate the current location 382 of an entity or a proximate a future known or predicted location 384 of the entity.

For example, an entity may be travelling to a future location (i.e., a travel destination) and the user may provide an input to a travel-related application that indicates a need to for resource allocation of a specific resource. In response, the instructions 306 may analyze the user's historical resource allocation event data to determine a type/brand of the resource that the user prefers and determine one or more resource allocators/providers along the predicted travel route of the user that currently stocks the resource and notifying the user, via alert or the like, the user of the on-route resource allocators. In other embodiments of the invention, the instructions 306 may analyze the user's historical resource allocation event data to determine a type/brand of the resource that the user prefers and determine one or more resource allocators/providers along the predicted travel route of the user that currently stocks the resource, signal one of the resource allocators along the route to allocate the resource to the user (i.e., purchase the resource or the like) and have the resource delivered to the predicted or known future location of the user (i.e., the travel destination of the user).

In another use case embodiment of the invention, a known or predicted future location (i.e., travel destination) of an entity/user may be determined, which may trigger an IoT device 300, such as smart refrigerator to detect the need for allocation of resource(s) (e.g., food items that the entity/user regularly uses) at the known or predicted future location or may trigger the entity/user to provide inputs (e.g., written or voice) that request the allocation of specific resources at the known or predicted future location. The system may determine one or more resource allocators/providers at the known or predicted travel location or along the predicted travel route of the entity/user and determine which resource allocators currently stock the resource. In response, the system may notify/alert the entity/user of the resource allocators at the known or predicted future location or along the travel route. In specific embodiment, the entity/user may respond to the alert by providing an input that allocates the resources to the entity (i.e., purchases the resources from one of the resource allocators) and provides for the resources to be delivered to the known or predicted future location of the user (i.e., the travel destination of the user) proximate in time to the entity's/user's arrival.

In still a further use case of the invention, a known or predicted future location (i.e., travel destination) of an entity/user may be determined, which may trigger analysis of historical resource allocation events and/or medical records to determine prescription medication allocations and preferred resource allocators (i.e., pharmacies). In response the entity/user may be alerted to the need to transfer the prescription to a preferred pharmacy proximate to the known or predicted future location of the entity or the prescription may be automatically transferred to a preferred resource allocator/pharmacy proximate to the known or predicted future location of the entity.

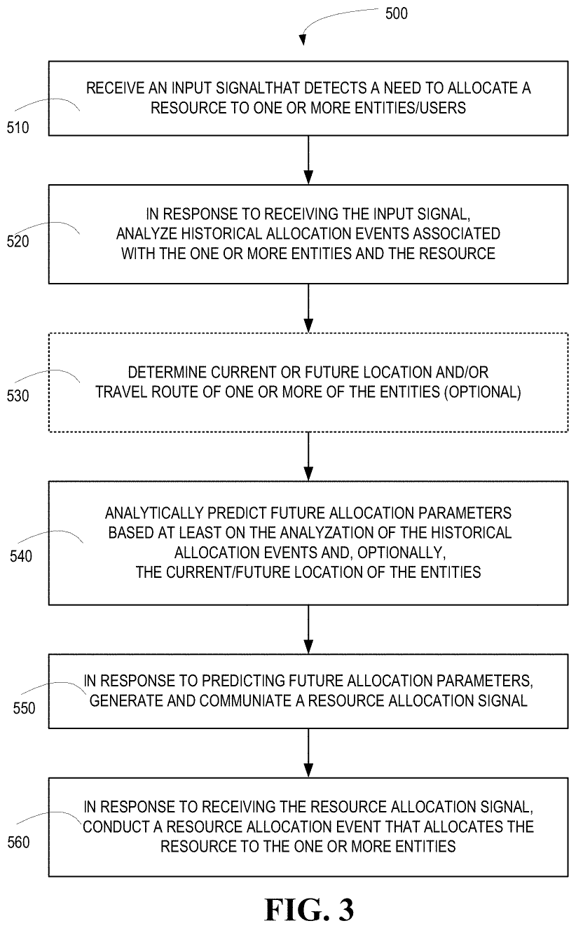

Referring to FIG. 3 a flow diagram diagram is presented of a method 500 for automated resource allocation based on predictive analysis, in accordance with embodiments of the present invention. In accordance with embodiments of the present invention, the methodology may be a series of instructions/codes stored one a computer-readable medium of a computer program product.

At Event 510, an input signal is received that detects a need to allocate a resource to one or more entities/users. The input signal may be provided by one or more sensors within an IoT device, such as sensors that detect the need to replace a consumable item used by the IoT device and/or the entity/user. In other embodiments of the invention, the input signal may be provided by the entity/user (e.g., written input, voice input) or the like. In still further embodiments of the invention, the input signal may be provided by an auxiliary device in control of a third-party entity that has been authorized by the entity/user to act on their respective behalf.

At Event 520, in response to receiving the input signal, historical allocation event data associated with the resource and the one or more entities is analyzed. Historical allocation event data may include, but is not limited to, past financial transaction data (e.g., debit/checking account data), medical data (e.g., prescription history), vehicle-related maintenance history data and the like. The historical allocation event data may be analyzed to determine preferred types/brands of the resource, preferred amount/quantities of previous allocations, preferred resource allocators/suppliers, preferred location of allocators/suppliers and the like.

At optional Event 530, a current or future/predicted location of the entity(s)/user(s) are determined. Current location of the entity/user may be determined from location-determining mechanisms (e.g., GPS or the like) within an IoT device (e.g., smart phone, portable computer/tablet, vehicle or the like). A future/predicted location of the entity/user may be determined based on the current location of the user, known or predicted travel routes of the entity/user, the entity's/user's user recent resource allocation history (e.g., travel services, such airline tickets, hotels and the like). Location determination may include a location along a known or predicted travel route. Known travel routes (e.g., route to and from a place of business, resource allocator facilities, family/friend places of residence or the like) may be determined over-time based on the user's location history. Predicted travel routes may be determined based on known/predicted future locations and the entity's/user's current location. In addition, location determination may not be limited to a single entity/user but may include the determination of the location of multiple users/entities (e.g., members of a household, employees at a place of business and the like). Such information on the current or future location of each user/entity may be used to determine whether an allocation should proceed or the specified amount/quantity of the allocation.

In specific embodiment of the invention, the determination of an entity's/user's location is a trigger to generating the input signal, while in other embodiments of the invention, the determination of the entity's/user's location is a further basis for determining allocation parameters (i.e., the determination of entity/user current or future location may occur prior to receiving the input signal or subsequent to the receipt of the input signal).

At Event 540, analytical processing is performed to predict/determine future allocation parameters for the resource based at least on the analyzation of the historical allocation event data and, optionally, the current and/or future location of the entity(s)/user(s). The allocation parameters may include, but are not limited to, the volume/quantity of the resource allocation, the timing of the resource allocation (e.g., date and/or time of day), the type/brand of the resource, the resource allocator(s)/supplier(s), the location of the resource allocation (i.e., where the resource should be delivered) and the like.

At Event 550, in response to predicting future allocation parameters, a resource allocation signal is generated and communicated via the distributed communication network to one or more resource allocators/suppliers. The resource allocation signal may include one or more of the allocation parameters, including, but not limited to, the volume/quantity of the resource allocation, the timing of the resource allocation, the type of resource, the resource allocator/supplier, the location for resource allocation and the like.

At Event 560, in response to receiving the resource allocation signal, a resource allocation event is conducted that allocates resources to the one or more entities and, in specific embodiments of the invention, in accordance with one or more of the allocation parameters.

Thus, systems, apparatus, methods, and computer program products described above provide for automated resource allocation based on predictive analysis/determination of allocation parameters associated with the resource and entities to whom the resource is to be allocated. In specific embodiments of the invention, the analytical analysis that predicts the future allocation parameters of the resource/entities is based at least on the entities historical resource allocation events, including, but not limited to, preferred types of the resource, amount/volume of previous resource allocations, timing of previous resource allocation and the like. In other embodiments of the invention, the analytical analysis that predicts the future allocation parameters is further based on the current or predicted location of at least one of the entities and/or the current or predicted travel route of at least one of the entities. In response to conducting the analytical analysis and predicting future usage needs, a resource allocation request signal, which may indicate resource amount and/or type, is generated and electronically communicated to resource allocator configured to automatically allocate the resource to the entity(s) in response to receiving the request.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for allocating resources, the system comprising:
an Internet-of-Things (IoT) device comprising a first computing platform including a first memory storing first instructions and at least one first processor in communication with the memory, wherein the at least one first processor is configured to execute the first instructions to:
receive an input signal that detects a need to allocate a resource to one or more entities,
in response to receiving the input:
analyze historical allocation events associated with the one or more entities and the resource,
analytically predict future allocation parameters for the resource and the one or more entities based at least on the analyzation of the historical allocation events,
in response to predicting the future allocation parameters for the resource, generate and communicate a resource allocation signal; and
a resource allocation apparatus comprising a second computing platform including a second memory storing second instructions and at least one second processor in communication with the second memory, wherein the at least one second processor is configured to execute the second instructions to:
in response to receiving the resource allocation signal, conduct a resource acquisition event that allocates the resource to the one or more entities.

2. The system of claim 1, wherein the at least one first processor is configured to execute the first instructions to:
determine at least one of a current location or predicted location of at least one of the one or more entities, and
analytically predict the future allocation parameters for the resource and the one or entities based further on the current location or predicted location of at least one of the entities.

3. The system of claim 2, wherein the at least one first processor is configured to execute the first instructions to:
in response to predicting the future allocation parameters for the resource, generate and communicate the resource allocation signal, wherein the resource allocation signal indicates an amount of the resource to be allocated to at least one of the one or more entities based on the predicted usage parameters.

4. The system of claim 1, wherein the at least one first processor is configured to execute the first instructions to:
determine a current or future travel route for at least one of the one or more entities,
determine one or more resource suppliers proximate in location to the current or future travel route, and
generate and communicate the resource allocation signal, wherein the resource allocation signal is communicated to at least one of the one or more resource suppliers.

5. The system of claim 1, wherein the at least one first processor is configured to execute the first instructions to:
analyze the historical allocation events associated with the one or more entities and the resource to determine one or more types of the resource previously allocated to at least one of the one or more entities.

6. The system of claim 5, wherein the at least one first processor is configured to execute the first instructions to:
determine a current or future travel route for at least one of the one or more entities,
determine one or more resource suppliers proximate in location to the current or future travel route and capable of allocating at least one of the one or more types of resource previously allocated to at least one of the one or more entities, and
generate and communicate the resource allocation signal, wherein the resource allocation signal is communicated to at least one of the one or more resource suppliers.

7. The system of claim 1, wherein the at least one first processor is configured to execute the first instructions to:
determine a predicted location of at least one of the one or more entities, and
receive the input that detects a need to allocate the resource to the one or more entities at the predicted location.

8. The system of claim 7, wherein the at least one first processor is configured to execute the first instructions to:
determine one or more resource suppliers proximate in location to the predicted location and capable of allocating the resource at a time associated with the predicted location, and
generate and communicate the resource allocation signal, wherein the resource allocation signal is communicated to the one or more resource suppliers.

9. The system of claim 1, wherein the IoT device further comprises one or sensors in communication with the first processors, wherein the one or more sensors are configured to detect the need to allocate the resource to the one or more entities and generate the input signal.

10. An Internet-of-Things (IoT) apparatus, the apparatus comprising:
a computing platform including a memory storing instructions and at least one processor in communication with the memory and configured to execute the instructions to:
receive an input signal that detects a need to allocate a resource to one or more entities;
in response to receiving the input:
analyze historical allocation events associated with the one or more entities and the resource;
analytically predict future allocation parameters for the resource and the one or more entities based at least on the analyzation of the historical allocation events; and
in response to predicting the future allocation parameters for the resource, generate and communicate a resource allocation signal,
wherein receipt of the resource allocation signal by a resource allocation apparatus prompts a resource acquisition event that allocates the resource to the one or more entities.

11. The IoT apparatus of claim 10, wherein the at least one processor is configured to execute the instructions to:
determine at least one of a current location or predicted location of at least one of the one or more entities; and
analytically predict the future allocation parameters for the resource and the one or entities based further on the current location or predicted location of at least one of the entities.

12. The IoT apparatus of claim 10, wherein the at least one processor is configured to execute the instructions to:
in response to predicting the future allocation parameters for the resource, generate and communicate the resource allocation signal, wherein the resource allocation signal indicates an amount of the resource to be allocated to at least one of the one or more entities based on the predicted usage parameters.

13. The IoT apparatus of claim 10, wherein the at least one processor is configured to execute the instructions to:
analyze the historical allocation events associated with the one or more entities and the resource to determine one or more types of the resource previously allocated to at least one of the one or more entities;
determine a current or future travel route for at least one of the one or more entities;
determine one or more resource suppliers proximate in location to the current or future travel route and capable of allocating at least one of the one or more types of resource previously allocated to at least one of the one or more entities; and
generate and communicate the resource allocation signal, wherein the resource allocation signal is communicated to at least one of the one or more resource suppliers.

14. The IoT apparatus of claim 10, wherein the at least one processor is configured to execute the instructions to:
determine a current or future travel route for at least one of the one or more entities;
determine one or more resource suppliers proximate in location to the current or future travel route; and
generate and communicate the resource allocation signal, wherein the resource allocation signal is communicated to at least one of the one or more resource suppliers.

15. The IoT apparatus of claim 10, wherein the at least one processor is configured to execute the instructions to:
determine a predicted location of at least one of the one or more entities, and
receive the input that detects a need to allocate the resource to the one or more entities at the predicted location.

16. The IoT apparatus of claim 15, wherein the at least one processor is configured to execute the instructions to:
determine one or more resource suppliers proximate in location to the predicted location and capable of allocating the resource at a time associated with the predicted location, and
generate and communicate the resource allocation signal, wherein the resource allocation signal is communicated to the one or more resource suppliers.

17. A computer program product including a non-transitory computer-readable medium, the computer-readable medium comprising:
a first set of codes for causing a computer to receive an input signal that detects a need to allocate a resource to one or more entities;
a second set of codes for causing a computer to, in response to receiving the input, analyze historical allocation events associated with the one or more entities and the resource and analytically predict future allocation parameters for the resource and the one or more entities based at least on the analyzation of the historical allocation events, and
a third set of codes for causing a computer to, in response to predicting the future allocation parameters for the resource, generate and communicate a resource allocation signal, wherein receipt of the resource allocation signal by a resource allocator prompts a resource acquisition event that allocates the resource to the one or more entities.

18. The computer program product of claim 17, wherein the computer-readable medium further includes:
a fourth set of codes for causing a computer to determine at least one of a current location or predicted location of at least one of the one or more entities; and
wherein the second set of codes is further configured to a fifth set of codes for analytically predict the future allocation parameters for the resource and the one or entities based further on the current location or predicted location of at least one of the entities.

19. The computer program product of claim 17, wherein the third set of codes is further configured to cause the computer to, in response to predicting the future allocation parameters for the resource, generate and communicate the resource allocation signal, wherein the resource allocation signal indicates an amount of the resource to be allocated to at least one of the one or more entities based on the predicted usage parameters.

20. The computer program product of claim 17, wherein the first set of codes is further configured to cause the computer to analyze the historical allocation events associated with the one or more entities and the resource to determine one or more types of the resource previously allocated to at least one of the one or more entities,
wherein computer-readable medium further comprises:
a fourth set of codes for causing a computer to determine the at least one processor is configured to execute the instructions to determine (i) a current or future travel route for at least one of the one or more entities and (ii) one or more resource suppliers proximate in location to the current or future travel route and capable of allocating at least one of the one or more types of resource previously allocated to at least one of the one or more entities, and
wherein the third set of codes is further configured to cause the computer to generate and communicate the resource allocation signal, wherein the resource allocation signal is communicated to at least one of the one or more resource suppliers.
